(19) United States
(12) Patent Application Publication
(10) Pub. No.: US 2017/0033720 A1
(43) Pub. Date: Feb. 2, 2017

(54) CONTROL SYSTEM FOR AN INDUCTION MOTOR

(71) Applicant: KMT Waterjet System Inc., Baxter Springs, KS (US)

(72) Inventors: Paul V. ZEYN, Joplin, MO (US); David L. LAWSON, Pittsburg, KS (US); Jeffrey D. STEPHENS, Pittsburg, KS (US)

(21) Appl. No.: 15/303,183

(22) PCT Filed: Apr. 24, 2015
(86) PCT No.: PCT/US2015/027427

§ 371 Date: Oct. 10, 2016

Related U.S. Application Data
(60) Provisional application No. 61/984,228, filed on Apr. 25, 2014.

(51) Int. Cl. H02P 25/18; H02P 1/32

(52) U.S. Cl. CPC H02P 25/184; H02P 1/32

(57) ABSTRACT

Control systems and methods for starting an induction motor. The control system includes a plurality of wye switches, a plurality of delta switches, an AC power supply, and a soft-starter. The plurality of wye switches are connected between three phase stator windings of the induction motor such that closure of the plurality of wye switches causes the three phase stator windings to be connected in a wye connection. The plurality of delta switches are connected between the three phase stator windings such that closure of the plurality of delta switches causes the three phase stator windings to be connected in a delta configuration. The soft-starter is connected between three phase supply lines of the AC power supply and the three phase stator windings to control a supply of energy to the induction motor from the AC power supply.

### RELATED APPLICATIONS

This application claims priority to U.S. Provisional Application No. 61/984,228, filed on Apr. 25, 2014 and titled “INDUCTION MOTOR STARTING SYSTEM,” the entire contents of which is incorporated by reference.

### BACKGROUND

The present invention relates to systems and methods of starting alternating current (AC) motors, including induction motors.

Today there are many types of electrical mechanical motor starting systems. Motor starting systems are used to accelerate a motor from its de-energized state to full speed. The type of starter that is used depends on the nature of the desired start, the desired characteristics, and control wiring. Full load amps (FLA) is an amperage at which a motor is designed to work at to achieve its rated horsepower. One measure of performance for a motor starting system is the peak current over the FLA. One conventional type of control system for a motor is a wye-delta system. The wye-delta system has a reduced peak current during the start of the wye sequence, but suffers from a high peak current during the transition from the wye sequence to the delta sequence. FIG. 1 illustrates a graph of the current flow in a wye-delta system while starting a motor. Conventional wye-delta systems require approximately 3.5 times FLA at start up and more than 7 times FLA at the wye to delta transition, as illustrated in FIG. 1. Another conventional type of motor starter system is a soft-starter. The soft-starter system does not have a wye to delta transition and therefore does not suffer from the high peak current caused by a wye to delta transition. The soft-starter system does, however, have a high peak current during the start of the starting sequence. FIG. 2 illustrates a graph of the current flow in a soft-starter system while starting a motor. Conventional soft-starter systems require approximately 5.5 times FLA, as illustrated in FIG. 2. In the graphs of FIGS. 1 and 2, the horizontal axis is time and the vertical axis is current.

### SUMMARY

In one implementation, the invention provides a control system for an induction motor. The induction motor includes three phase stator windings. The control system includes a plurality of wye switches, a plurality of delta switches, a soft-starter, and a controller. The plurality of wye switches are connected between the three phase stator windings such that closure of the plurality of wye switches causes the three phase stator windings to be connected in a wye configuration. The plurality of delta switches are connected between the three phase stator windings such that closure of the plurality of delta switches causes the three phase stator windings to be connected in a delta configuration. The soft-starter including a plurality of bypass switches and a plurality of switching devices. The plurality of bypass switches and the plurality of switching devices are connected between the three phase stator windings and three phase supply lines of an AC power supply to control a supply of energy to the induction motor from the AC power supply. The controller is in electronic communication with the plurality of wye switches, the plurality of delta switches, and the soft-starter. The controller is configured to close the plurality of wye switches when the induction motor is started. The controller is also configured to activate the soft-starter when the plurality of wye switches are closed. The controller is further configured to open the plurality of wye switches when a speed of the induction motor is greater than a threshold. The controller is also configured to deactivate the soft-starter when the plurality of wye switches are opened. The controller is further configured to close the plurality of delta switches when the soft-starter is deactivated. The controller is also configured to re-activate the soft-starter when the plurality of delta switches are closed.

In another implementation, the invention provides a method of starring an induction motor. The induction motor includes three phase stator windings. The method includes connecting, via a plurality of wye switches, the three phase stator windings in a wye configuration when the induction motor is started. The method also includes ramping, via a soft-starter, a supply of energy to the induction motor from an AC power supply when the three phase stator windings are configured in the wye configuration. The method further includes disconnecting, via the soft-starter, the three phase stator windings from the AC power supply when a speed of the induction motor is greater than a threshold. The method also includes connecting, via a plurality of delta switches, the three phase stator windings in a delta configuration when the three phase stator windings are disconnected from the AC power supply. The method further includes ramping, via the soft-starter, the supply of energy to the induction motor from the AC power supply when the three phase stator windings are configured in the delta configuration.

In another implementation, the invention provides a control system for an induction motor. The induction motor includes three phase stator windings. The control system includes a plurality of wye switches, a plurality of delta switches, a soft-starter, and a controller. The plurality of wye switches are connected between the three phase stator windings such that closure of the plurality of wye switches causes the three phase stator windings to be connected in a wye configuration. The plurality of delta switches are connected between the three phase stator windings such that closure of the plurality of delta switches causes the three phase stator windings to be connected in a delta configuration. The soft-starter including a plurality of bypass switches and a plurality of switching devices. The plurality of bypass switches and the plurality of switching devices are connected between the three phase stator windings and three phase supply lines of an AC power supply to control a supply of energy to the induction motor from the AC power supply. The controller is in electronic communication with the plurality of wye switches, the plurality of delta switches, and the soft-starter. The controller is configured to connect the three phase stator windings in one of the delta configuration and the wye configuration. The controller is also configured to activate and deactivate the soft-starter.

Other aspects of the invention will become apparent by consideration of the detailed description and accompanying drawings.

### BRIEF DESCRIPTION OF THE DRAWINGS

FIG. 1 is a graph of the current flow during a starting sequence with a wye-delta system.

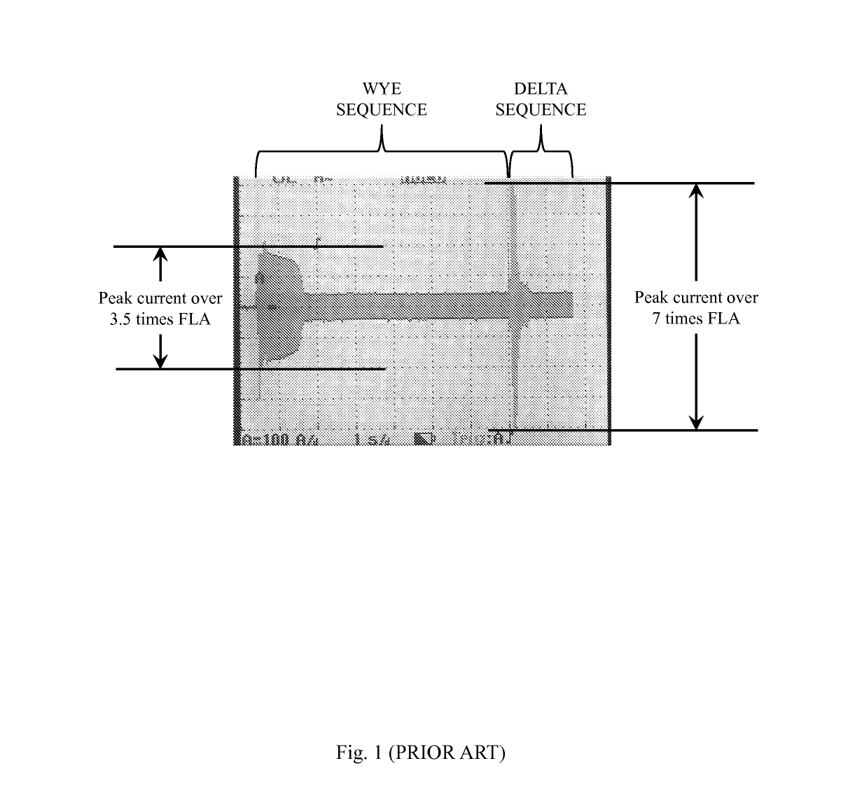

FIG. 2 is a graph of the current flow during a starting sequence with a soft-starter system.

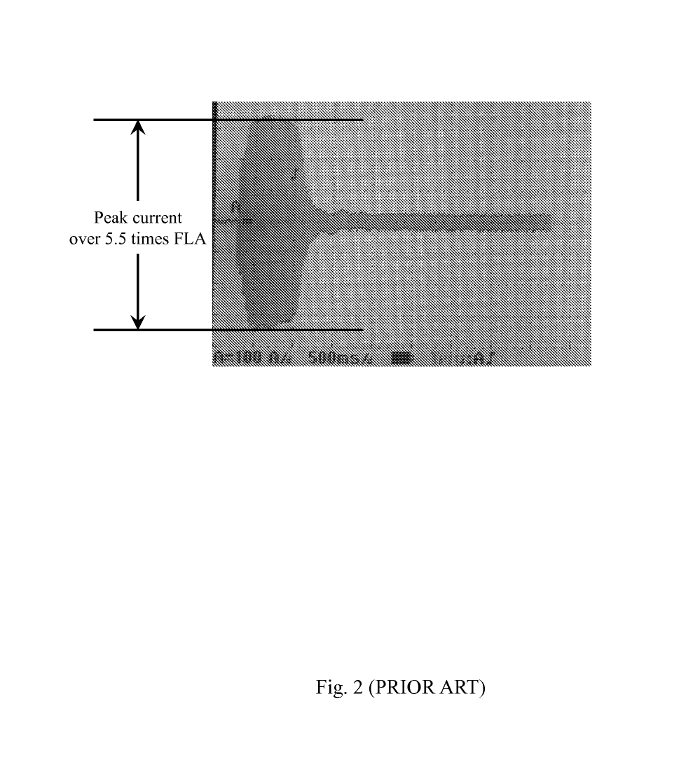

FIG. 3 is a block diagram of a control system for an induction motor, wired in an inside delta configuration.

FIG. 4 is a block diagram of a control system for an induction motor, wired in an outside delta configuration.

FIG. 5 represents a process for starting an induction motor.

FIG. 6 is a graph of the current flow during a starting sequence with the control systems of FIGS. 3 and 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. The term “set” is used broadly to refer to one or more. Also, electronic communications and notifications may be performed using other known means including direct connections, wireless connections, etc.

It should also be noted that a plurality of hardware and software based devices, as well as a plurality of different structural components may be utilized to implement the invention. Furthermore, and as described in subsequent paragraphs, the specific configurations illustrated in the drawings are intended to exemplify implementations of the invention. Alternative configurations are possible.

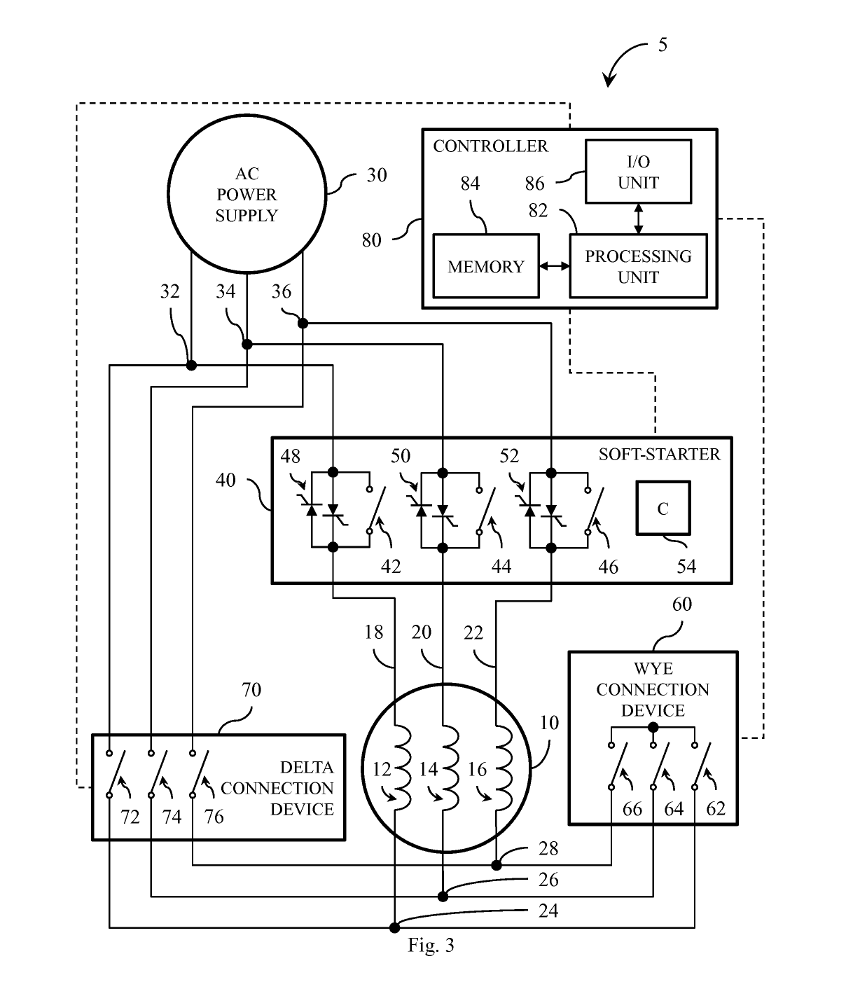

A control system 5 for an induction motor 10, includes, among other components, the induction motor 10, an AC power supply 30, a soft-starter 40, a wye connection device 60, a delta connection device 70, and a controller 80, as illustrated in FIG. 3. The induction motor 10 includes, among other components, three phase stator windings 12, 14, 16, and motor terminals 18, 20, 22, 24, 26, 28. The induction motor 10 is an AC electric motor in which the electric current in a rotor (not shown) needed to produce torque is induced by electromagnetic induction from the magnetic field of the three phase stator windings 12, 14, 16. The induction motor 10 is, for example, a squirrel-cage induction motor, a wound induction motor, etc.

The AC power supply 30 provides three phase AC voltage to the induction motor 10 via three phase supply lines 32, 34, 36. In some implementations, the AC power supply 30 is powered by one or more batteries or battery packs. The three phase stator windings 12-16 are operatively connected to the AC power supply 30 through corresponding three phase supply lines 32-36 at motor terminals 18-22.

The soft-starter 40 is an electronic device that controls the voltage, current, and/or frequency input to the induction motor 10. By reducing the voltage, current, and/or frequency input, the soft-starter 40 reduces the torque produced by the induction motor 10. The soft-starter 40 uses solid state devices to control the current flow and therefore the voltage applied to the three phase stator windings 12-16. The soft-starter 40 includes, among other components, a plurality of bypass switches 42, 44, 46 (e.g., contactors, relays, etc.) and switching devices 48, 50, 52 corresponding to each of the three phase supply lines 32-36 and motor terminals 18-22. The switching devices 48-52 include, among other components, pairs of anti-parallel switches (e.g., silicon controlled rectifiers, thyristors, etc.). A pair of anti-parallel switches are two switches which are opposite in polarity and connected in parallel to each other.

In some implementations, the soft-starter 40 also includes a controller 54. Upon activation, the soft-starter 40 operates in a ramping mode, during which the controller 54 causes one or more of the bypass switches 42- 46 to open such that the supply of energy provided to the induction motor 10 from AC power supply 30 passes through the switching devices 48-52. The controller 54 gradually ramps (i.e., increases) the supply of energy to increase a speed (e.g., rotational speed of the rotor) of the induction motor 10. The controller 54 determines the speed of the induction motor 10 and continues to ramp the supply of power until the speed of the induction motor 10 is above a threshold. In some implementations, the threshold is a predetermined value.

The soft-starter 40 enters a bypass mode of operation upon detecting that the speed of the induction motor 10 is above the threshold. In some implementations, the controller 54 transmits a motor at speed (e.g., top of ramp, bypass output, etc.) signal upon detecting that the speed of the induction motor 10 is above the threshold. While operating in the bypass mode, the controller 54 causes bypass switches 42-46 to close, so as to bypass the switching devices 48-52 and minimize power dissipation. The bypass mode can be considered a normal mode of operation for the soft-starter 40. In some implementations, the plurality of bypass switches 42-46 are opened when the soft-starter 40 is deactivated.

The wye connection device 60 includes, among other components, a plurality of wye switches 62, 64, 66, corresponding to motor terminals 24-28. When the plurality of wye switches 62-66 are in a closed position, motor terminals 24-28 are connected together. Closure of the plurality of wye switches 62-66 causes the three phase stator windings 12-1 to be connected in a wye configuration.

The delta connection device 70 includes, among other components, a plurality of delta switches 72, 74, 76, corresponding to motor terminals 24-28. When the plurality of delta switches 72-76 are in a closed position, motor terminals 24-28 are connected, directly or indirectly, to motor terminals 18-22. Closure of the plurality of delta switches 72-76 causes the three phase stator windings 12-16 to be connected in a delta configuration.

In some implementations, the three phase stator windings 12-16 are considered to be in the wye configuration when the plurality of wye switches 62-66 are in the closed position and the plurality of delta switches 72-76 are in the open position. In some implementations, the three phase stator windings 12-16 are considered to be in the delta configuration when the plurality of wye switches 62-66 are in the open position and the plurality of delta switches 72-76 are in the closed position. In some implementations, the three phase stator windings 12-16 are considered to be disconnected from the AC power supply when the soft-starter 40 is deactivated, the plurality of wye switches 62-66 are in the opened position, and the plurality of delta switches 72-76 are in the open position.

FIG. 3 illustrates an inside delta configuration. In the inside delta configuration, the plurality of delta switches 72-76, the plurality of bypass switches 42-46, and the plurality of switching devices 48-52 are connected in parallel. In some implementations, the plurality of delta switches 72-76, the plurality of bypass switches 42-46, and the plurality of switching devices 48-52 are connected in the inside delta configuration.

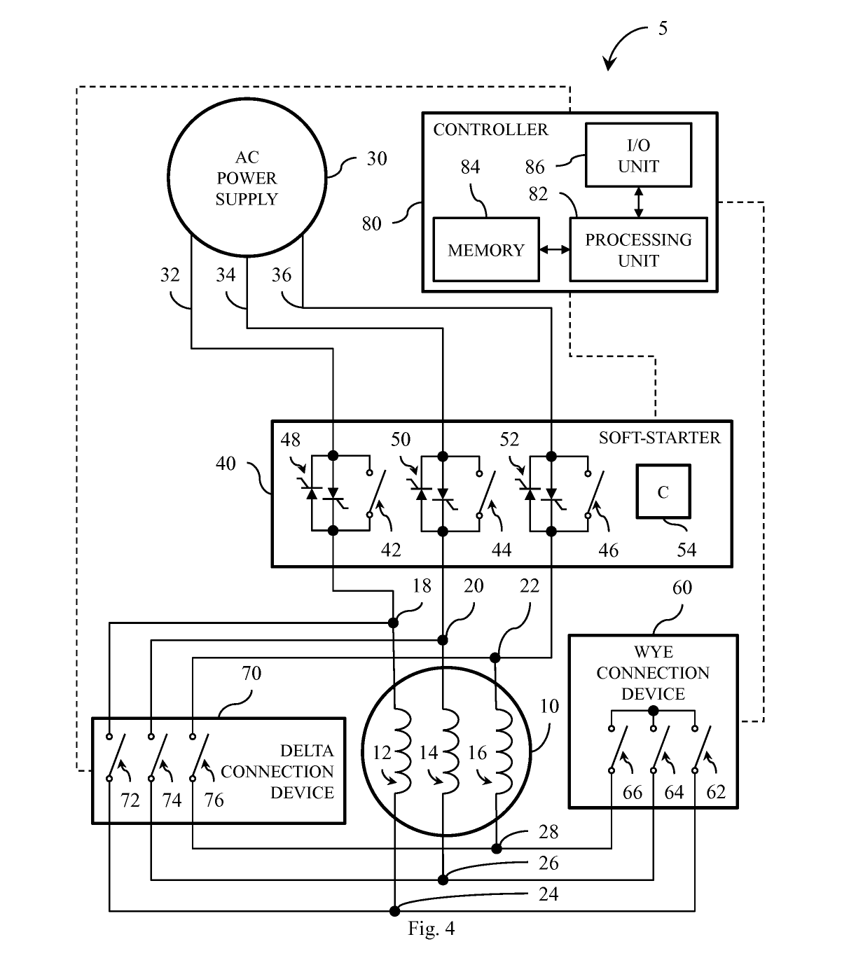

FIG. 4 illustrates an outside delta configuration. In the outside delta configuration, the plurality of delta switches 72-76 are connected in series with the plurality of bypass switches 42-46 and the plurality of switching devices 48-52. In some implementations, the plurality of delta switches 72-76, the plurality of bypass switches 42-46, and the plurality of switching devices 48-52 are connected in the outside delta configuration.

The controller 80 includes, or is connected to an external device (e.g., a computer), which includes combinations of software and hardware that are operable to, among other things, control the operation of the control system 5. In one implementation, the controller 80 or external device includes a printed circuit board (PCB) that is populated with a plurality of electrical and electronic components that provide, power, operational control, and protection to control system 5. In some implementations, the PCB includes, for example, a processing unit 82 (e.g., a microprocessor, a microcontroller, or another suitable programmable device), a memory 84, and a bus. The bus connects various components of the PCB including the memory 84 to the processing unit 82. The memory 84 includes, for example, a read-only memory (ROM), a random access memory (RAM), an electrically erasable programmable read-only memory (EEPROM), a flash memory, a hard disk, or another suitable magnetic, optical, physical, or electronic memory device. The processing unit 82 is connected to the memory 84 and executes software that is capable of being stored in the RAM (e.g., during execution), the ROM (e.g., on a generally permanent basis), or another non-transitory computer readable medium such as another memory or a disc. Additionally or alternatively, the memory 84 is included in the processing unit 82. The controller 80 also includes an input/output (I/O) unit 86 that includes routines for transferring information between or issuing command signals to components within the controller 80 and other components of the control system 5.

Software included in some implementations of the control system 5 is stored in the memory 84 of the controller 80. The software includes, for example, firmware, one or more applications, program data, one or more program modules, and other executable instructions. The controller 80 is configured to retrieve from memory 84 and execute, among other components, instructions related to the control processes and methods described below. For example, the controller 80 is configured to execute instructions retrieved from the memory 84 to determine when the plurality of wye switches 62-66 and the plurality of delta switches 72-76 should be in the open position and in the closed position. In some implementations, the controller 80 is configured to execute the operations of the controller 54 in the soft-starter 40, described above. In some implementations, the controller 80 or external device includes additional, fewer, or different components.

The PCB also includes, among other components, a plurality of additional passive and active components such as resistors, capacitors, inductors, integrated circuits, and amplifiers. These components are arranged and connected to provide a plurality of electrical functions to the PCB including, among other things, filtering, signal conditioning, or voltage regulation. For descriptive purposes, the PCB and the electrical components populated on the PCB are collectively referred to as the controller 80.

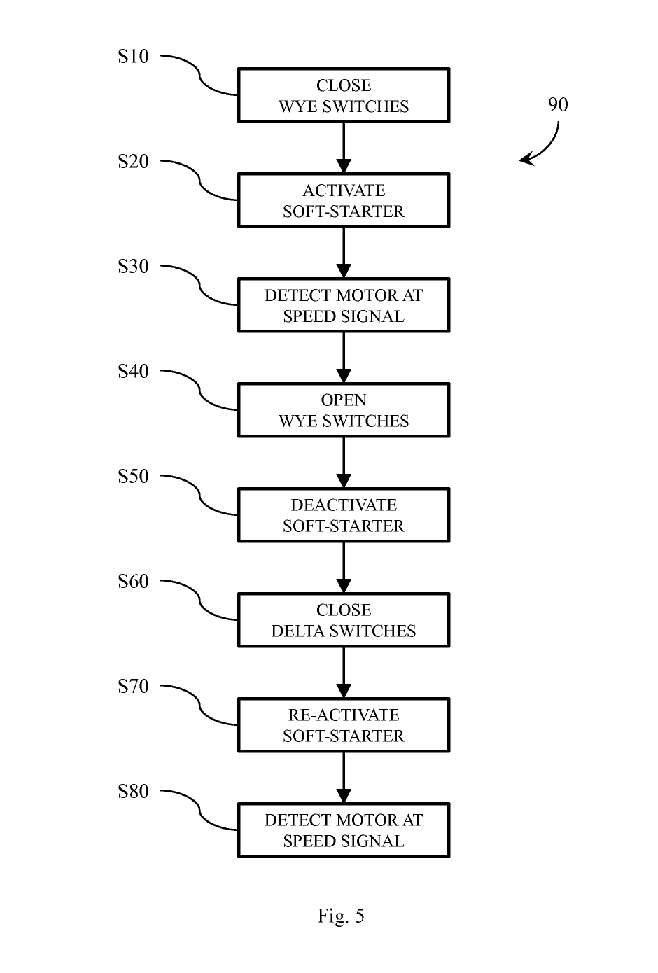

FIG. 5 illustrates a process 90 (or method) for starting the induction motor 10. The steps of the process 90 are described in an iterative manner for descriptive purposes. Various steps described herein with respect to the process 90 are capable of being executed simultaneously, in parallel, or in an order that differs from the illustrated serial and iterative manner of execution. The plurality of wye switches 62-66 are placed in the closed position and no current flows from the AC power supply 30 to the induction motor 10 (step 10). In other words, the three phase stator windings 12-16 are connected in the wye configuration. Next, the soft-starter 40 is activated and current flows from the AC power supply 30 to the induction motor 10 (step 20). The controller 80 receives a motor at speed signal from the soft-starter 40 (step 30). After the controller 80 receives the motor at speed signal, the plurality of wye switches 62-66 are placed in the open position (step 40). The soft-starter 40 is deactivated and no current flows from the AC power supply 30 to the induction motor 10 (step 50). The plurality of delta switches 72-76 are placed in the closed position (step 60). In other words, the three phase stator windings 12-16 are connected in the delta configuration. Next, the soft-starter 40 is re- activated and current flows from the AC power supply 30 to the induction motor 10 (step 70). The controller 80 receives the motor at speed signal from the soft-starter 40 and the induction motor 10 is at full speed and full torque capacity (step 80).

It is to be understood that the process 90 described above can be executed in reverse order to provide a method of stopping the induction motor 10. The stopping and starting methods, discussed above, increase energy efficiency by allowing the controller 80 to put the induction motor 10 into the wye configuration with reduced energy consumption.

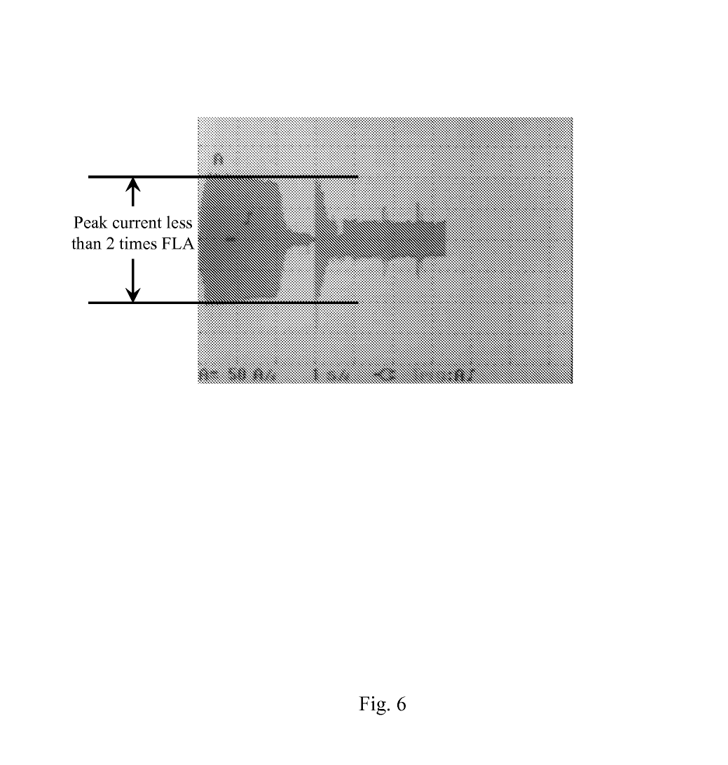

FIG. 6 illustrates a graph of the current flow in the control system 5 while starting the induction motor 10. In the graph of FIG. 6, the horizontal axis is time and the vertical axis is current. The peak current of the control system 5 is less than 2 times FLA. Therefore, among other things, the invention provides systems and methods of starting an induction motor 10 using a soft-starter 40, a wye connection device 60, and a delta connection device 70 for increased energy conservation.

What is claimed is:

1. A control system for an induction motor including three phase stator windings, the control system comprising:
a plurality of wye switches connected between the three phase stator windings such that closure of the plurality of wye switches causes the three phase stator windings to be connected in a wye configuration;
a plurality of delta switches connected between the three phase stator windings such that closure of the plurality of delta switches causes the three phase stator windings to be connected in a delta configuration;
a soft-starter including a plurality of bypass switches and a plurality of switching devices connected between the three phase stator windings and three phase supply lines of an AC power supply to control a supply of energy to the induction motor from the AC power supply; and
a controller in electronic communication with the plurality of wye switches, the plurality of delta switches, and the soft-starter, the controller configured to:
close the plurality of wye switches when the induction motor is started, activate the soft-starter when the plurality of wye switches are closed, open the plurality of wye switches when a speed of the induction motor is greater than a threshold,
deactivate the soft-starter when the plurality of wye switches are opened,
close the plurality of delta switches when the soft-starter is deactivated, and
re-activate the soft-starter when the plurality of delta switches are closed.

2. The control system of claim 1, wherein the plurality of delta switches, the plurality of bypass switches and the plurality of switching devices are connected in an inside delta configuration.

3. The control system of claim 1, wherein the plurality of delta switches, the plurality of bypass switches and the plurality of switching devices are connected in an outside delta configuration.

4. The control system of claim 1, wherein the plurality of bypass switches are closed when the speed of the induction motor is greater than the threshold and open when the speed of the induction motor is less than or equal to the threshold.

5. The control system of claim 4, wherein the plurality of bypass switches are open when the soft-starter is deactivated.

6. The control system of claim 1, wherein the soft-starter includes a second controller configured to:
determine the speed of the induction motor,
detect when the speed of the induction motor is greater than the threshold, and
transmit a signal when the speed of the induction motor is greater than the threshold.

7. The control system of claim 6, wherein the controller is further configured to receive the signal from the second controller.

8. The control system of claim 1, wherein the controller is further configured to:
determine the speed of the induction motor, and
detect when the speed of the induction motor is greater than the threshold.

9. The control system of claim 1, wherein the induction motor includes one type of motor selected from a group consisting of a squirrel-cage induction motor and a wound induction motor.

10. The control system of claim 1, wherein the plurality of switching devices includes a plurality of anti-parallel switches.

11. A method of starting an induction motor including three phase stator windings, the method comprising:
connecting, via a plurality of wye switches, the three phase stator windings in a wye configuration when the induction motor is started;
ramping, via a soft-starter, a supply of energy to the induction motor from an AC power supply when the three phase stator windings are configured in the wye configuration;
disconnecting, via the soft-starter, the three phase stator windings from the AC power supply when a speed of the induction motor is greater than a threshold;
connecting, via a plurality of delta switches, the three phase stator windings in a delta configuration when the three phase stator windings are disconnected from the AC power supply; and
ramping, via the soft-starter, the supply of energy to the induction motor from the AC power supply when the three phase stator windings are configured in the delta configuration.

12. The method of claim 11, wherein connecting the three phase stator windings in the wye configuration includes closing the plurality of wye switches and opening the plurality of delta switches.

13. The method of claim 12, wherein connecting the three phase stator windings in the delta configuration includes opening the plurality of wye switches and closing the plurality of delta switches.

14. The method of claim 11, wherein ramping the supply of energy to the induction motor from the AC power supply includes activating the soft-starter.

15. The method of claim 14, wherein disconnecting the three phase stator windings from the AC power supply includes opening the plurality of wye switches and deactivating the soft-starter.

16. The method of claim 11, further comprising:
determining, via a controller, the speed of the induction motor; and
detecting, via the controller, when the speed of the induction motor is greater than the threshold.

17. The method of claim 11, wherein the induction motor includes one type of motor selected from a group consisting on a squirrel-cage induction motor and a wound induction motor.

18. A control system for an induction motor including three phase stator windings, the control system comprising:
a plurality of wye switches connected between the three phase stator windings such that closure of the plurality of wye switches causes the three phase stator windings to be connected in a wye configuration;
a plurality of delta switches connected between the three phase stator windings such that closure of the plurality of delta switches causes the three phase stator windings to be connected in a delta configuration;
a soft-starter including a plurality of bypass switches and a plurality of switching devices connected between the three phase stator windings and three phase supply lines of an AC power supply to control a supply of energy to the induction motor from the AC power supply; and
a controller in electronic communication with the plurality of wye switches, the plurality of delta switches, and the soft-starter, the controller configured to:
connect the three phase stator windings in one of the delta configuration and the wye configuration, and
activated and deactivate the soft-starter.

19. The control system of claim 18, wherein the plurality of delta switches, the plurality of bypass switches, and the plurality of switching devices are connected in an inside delta configuration.

20. The control system of claim 18, wherein the plurality of delta switches, the plurality of bypass switches, and the plurality of switching devices are connected in an outside delta configuration.
